(19) United States
(12) Patent Application Publication
(10) Pub. No.: US 2006/0098993 A1
(43) Pub. Date: May 11, 2006

(54) Method and apparatus for verifying genuineness of a consumable part

(75) Inventor: Woo-Seong Yang, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/270,667

(22) Filed: Nov. 10, 2005

(30) Foreign Application Priority Data
Nov. 11, 2004 (KR) 2004-0092032

(51) Int. Cl. G03G 15/00

(52) U.S. Cl. 399/12

(57) ABSTRACT

A method and apparatus are disclosed for verifying genuineness of consumable parts. The method for verifying genuineness of a consumable part comprises mounting a consumable part and detecting resistance value of a resistor coupled to the consumable part. The method generates encoded data by encoding the resistance value through an encoding algorithm, and compares the generated encoded data with pre-stored encoded data within a memory chip of the consumable part. When the generated encoded data is the same as the pre-stored data, it is determined that the consumable part is genuine. Accordingly, genuineness of the consumable part can be correctly determined.

### CROSS-REFERENCE TO RELATED APPLICATIONS

This application claims the benefit under 35 U.S.C. § 119(a) of Korean Patent Application No. 10-2004-0092032, filed Nov. 11, 2004, in the Korean Intellectual Property Office, the entire disclosure of which is hereby incorporated by reference.

### BACKGROUND OF THE INVENTION

1. Field of the Invention

The present invention relates to identification of a consumable part. More particularly, the present invention relates to identifying the genuineness of consumable parts, an image forming apparatus capable of identifying genuineness of a consumable part, a method for manufacturing such consumable parts, and a method for identifying genuineness of a consumable part in an image forming apparatus.

2. Description of the Related Art

Image forming apparatuses, such as printers and photocopiers, typically receive commodity information about a consumable part, such as a toner cartridge, as an input to the main body of the apparatus. Thus, the image forming apparatus can be controlled based on the input of commodity information. For example, a network printer connected to a personal computer receives information regarding the remaining toner amount within a toner cartridge. This input information is transmitted to a host computer so that the host computer can display the remaining toner amount through a screen or user interface. Therefore, a user can easily know when to replace the toner cartridge.

In image forming apparatuses, such as printers and photocopiers, through input of commodity information about a consumable part, such as a toner cartridge, the image forming apparatus can identify the consumable part, such as the kind of toner used in the toner cartridge. In order to input the commodity information to the main body of the image forming apparatus, and thus control the image forming apparatus based on the input information, a memory device is provided that transmits the information from the consumable part to the main body. However, existing methodology does not permit identification of consumable parts through the commodity information input to the memory device. Thus, conventional systems cannot determine whether a consumable part is genuine or counterfeit.

Accordingly, there is a need for equipment, such as image forming apparatuses, that can test a consumable part and identify whether that part is genuine or counterfeit.

### SUMMARY OF THE INVENTION

Aspects of the present invention are directed to solve at least the above problems and/or disadvantages and to provide at least the advantages described below. Accordingly, an aspect of the present invention provides a device, such as an image forming apparatus, capable of identifying the genuineness of a consumable part, which is removable, by performing authentication to protect the device from accepting a counterfeit part. Thus, good quality can be assured through the genuineness of the consumable part.

In accordance with another aspect of the present invention, there is provided a consumable part having the capability of verifying genuineness. The consumable part comprises a main body having at least one resistor coupled thereto, and a memory chip storing encoded data generated from the resistance detected and processed through an encoding algorithm.

In one exemplary embodiment the resistor comprises a resistor in which resistance value varies according to the specific consumable part. Resistance is detected under a predetermined ambient temperature.

The consumable part refers to an exhaustible replaceable part consumed through use and, for example, can comprise a cartridge detachably mounted to an image forming apparatus and various belts.

In one exemplary embodiment, the predetermined encoding algorithm is embodied by a Message Digest 5 (MD5) algorithm. The encoded data is 128-bit data.

Resistance is used for encoding within a predetermined tolerance range and facilitates discrimination between different consumable parts.

In another exemplary embodiment of the present invention, there is provided a method of manufacturing a consumable part having the capability of verifying genuineness. The method comprises coupling at least one resistor to the consumable part, encoding a detected resistance of the resistor through an encoding algorithm and thereby generating encoded data, and storing the encoded data to a memory chip.

An image forming apparatus according to aspects of the present invention comprise a part insertion unit for mounting a consumable part capable of identifying genuineness. The apparatus further comprises a main body having at least one resistor attached thereto and a memory chip for storing encoded data. The encoded data is generated from a detected resistance of the resistor through an encoding algorithm. A resistance detector detects resistance of the resistor coupled to the consumable part mounted in the part insertion unit. The apparatus further comprises a controller capable of encoding the detected resistance using an encoding algorithm, thereby generating encoded data, and determining the genuineness of the consumable part mounted to the part insertion unit. The consumable part is determined to be genuine when the generated encoded data is identical to pre-stored encoded data as a result of comparison. In one exemplary embodiment the resistance detector comprises a sensor.

The image forming apparatus comprises a temperature detector for detecting ambient temperature of the image forming apparatus, and a resistance compensator for compensating the resistance detected by the resistance detector based on a difference between the detected temperature and a temperature preset during the manufacture of the consumable part. Thus, the resistance compensator generates a compensated resistance and supplies the compensated resistance to the controller.

The controller encoding the compensated resistance uses an encoding algorithm to generate encoded data and, using the encoded data, determine whether the consumable part mounted to the part insertion unit is genuine. The consumable part is determined to be genuine when the generated encoded data is identical to pre-stored encoded data as a result of comparison performed by the controller. In one exemplary embodiment, the image forming apparatus further comprises a storage which stores a software program for executing the encoding algorithm.

In another aspect of the present invention, a method for identifying genuineness of a consumable part comprises mounting a consumable part and detecting a resistance of a resistor attached to the consumable part. The method further comprises generating encoded data by encoding the resistance using an encoding algorithm, and comparing the generated encoded data and encoded data pre-stored to a memory chip of the consumable part. When the generated encoded data is identical to the pre-stored data, the method determines the consumable part to be genuine.

The method further comprises encoding a compensated resistance using an encoding algorithm and generating encoded data. The method further comprises determining the consumable part to be genuine when the generated encoded data is identical to pre-stored encoded data as a result of comparison.

### BRIEF DESCRIPTION OF THE DRAWING FIGURES

The above aspects and exemplary features of the present invention will become more apparent by describing in detail exemplary embodiments thereof with reference to the accompanying drawing figures, in which:

FIG. 1 illustrates a perspective view schematically showing a consumable part in accordance with an exemplary embodiment of the present invention;

FIG. 2 shows a block diagram illustrating the structure of an image forming apparatus capable of verifying genuineness of a consumable part, according to an embodiment of the present invention;

FIG. 3 shows a flowchart of a method for manufacturing consumable parts having the function of verifying genuineness thereof in accordance with an exemplary embodiment of the present invention;

FIG. 4 shows a chart for presenting a method of determining the resistance of a resistor; and

FIG. 5 shows a flowchart of a method for identifying genuineness of a consumable part in an image forming apparatus in accordance with an exemplary embodiment of the present invention.

Throughout the drawings, like reference numbers should be understood to refer to like elements, features, and structures.

### DETAILED DESCRIPTION OF EXEMPLARY EMBODIMENTS

Hereinafter, exemplary embodiments of the present invention will be described in greater detail with reference to the accompanying drawing figures. The matters exemplified in this description are provided to assist in a comprehensive understanding of various embodiments of the present invention disclosed with reference to the accompanying figures. Accordingly, those of ordinary skill in the art will recognize that various changes and modifications of the exemplary embodiments described herein can be made without departing from the scope and spirit of the claimed invention. Descriptions of well-known functions and constructions are omitted for clarity and conciseness.

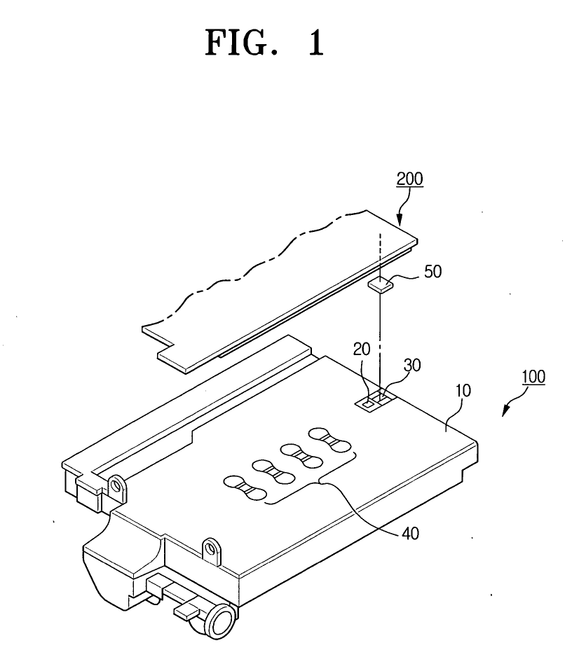

FIG. 1 illustrates a perspective view schematically showing a consumable part having a function of verifying genuineness thereof in accordance with an exemplary embodiment of the present invention. Referring to FIG. 1, consumable part 100 having a function of verifying genuineness thereof, comprises a main body 10, a memory chip 20 mounted on the main body 10, a connection pad 30, and at least one resistor 40. Here, ‘consumable part’ 100 refers to a part which needs replacement after being exhausted, such as a belt or a cartridge comprising a drum and toner.

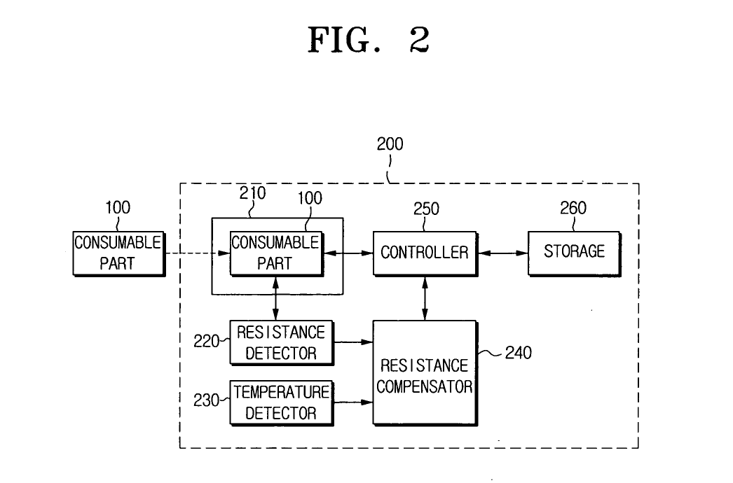

Memory chip 20 preferably comprises an electrically erasable programmable read-only memory (EEPROM). Upon mounting of consumable part 100 to an image forming apparatus 200, the connection pad 30 automatically connects memory chip 20 with a controller 250 (FIG. 2) of the image forming apparatus 200 through a connection terminal 50. During manufacture of consumable part 100, resistance of at least one of the one or more resistors 40 mounted on the main body 10 is measured. The measured resistance is encoded by a Message Digest 5 (MD5) algorithm, thereby generating 128-bit encoded data. The 128-bit encoded data is stored in memory chip 20 of consumable part 100 and used to discriminate genuineness of the consumable part.

The encoded resistance stored in memory chip 20 may comprise encoded resistance values for each of one or more resistors 40 separately or a combination thereof. That is, a resistance value of one resistor may be encoded, and then an aggregate resistance value of the remaining resistors is separately encoded. Alternatively, a single resistance value representative of an aggregate resistance of the one or more resistors 40 may be encoded and stored in memory chip 20. Because resistors have different resistance values, within a manufacturing tolerance, the encoded resistance value is unique to each consumable part 100. FIG. 1 illustrates four discrete resistors representing the one or more resistors 40 but the present invention is not limited to this quantity.

FIG. 2 shows a block diagram illustrating the structure of an image forming apparatus capable of verifying genuineness of a consumable part, according to an exemplary embodiment of the present invention. Referring to FIG. 2, the image forming apparatus 200 capable of identifying genuineness of a consumable part mounted therein, comprises part insertion unit 210, resistance detector 220, temperature detector 230, resistance compensator 240, controller 250 and storage 260.

Consumable part 100 is mounted into image forming apparatus 200 through the part insertion unit 210 so that mutual communication between the consumable part 100 and the image forming apparatus 200 is enabled. Resistance detector 220 detects the resistance of the at least one of the one or more resistors 40 within consumable part 100 mounted on the part insertion unit 210 and transmits the detected resistance to resistance compensator 240. The resistance detector 220 detects the resistance of fixed resistor 40 via a sensor.

Temperature detector 230 detects ambient temperature of the image forming apparatus 200 and provides the detected temperature value to resistance compensator 240. The resistance compensator 240 compensates for the detected resistance value supplied from resistance detector 220 according to the temperature detected by temperature detector 230 and thereby generates a compensated resistance value. The compensated resistance value generated in the resistance compensator 240 is transmitted to controller 250.

Storage 260 contains, in part, a system program and other assorted software for operating the image forming apparatus 200. An encoding program is stored within storage 260 to generate the 128-bit encoded data from the input data and authenticate data integrity.

Controller 250 reads the encoding program stored within storage 260 and executes an encoding algorithm to encode the compensated resistance value supplied from resistance compensator 240, thereby generating encoded data. In one exemplary embodiment of the present invention, the algorithm is the MD5 algorithm. However, the present invention is not limited to use of the MD5 algorithm and may employ any suitable algorithm capable of encoding.

Controller 250 compares the encoded data, which is generated through the encoding algorithm, with the encoded data that is pre-stored within memory chip 20 of consumable part 100. Thus, controller 250 verifies the genuineness of the consumable part mounted in the image forming apparatus 200.

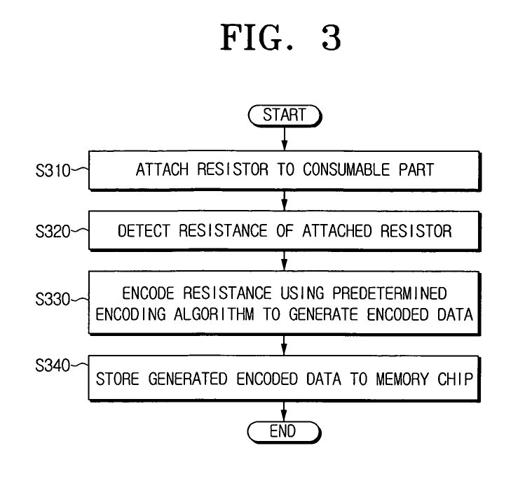

FIG. 3 shows a flowchart describing the steps of a method for manufacturing consumable parts having a function of identifying genuineness thereof in accordance with an exemplary embodiment of the present invention. According to the manufacture method of consumable part 100, at least one resistor 40 is coupled to consumable part 100 (S310). Deflection of the resistance of resistor 40 is relatively large among parts. The resistance of resistor 40 is then detected (S320). In one exemplary embodiment, resistor 40 is a resistor, thus detection of resistance is typically performed at room temperature using a customary method of detecting resistance of a resistor.

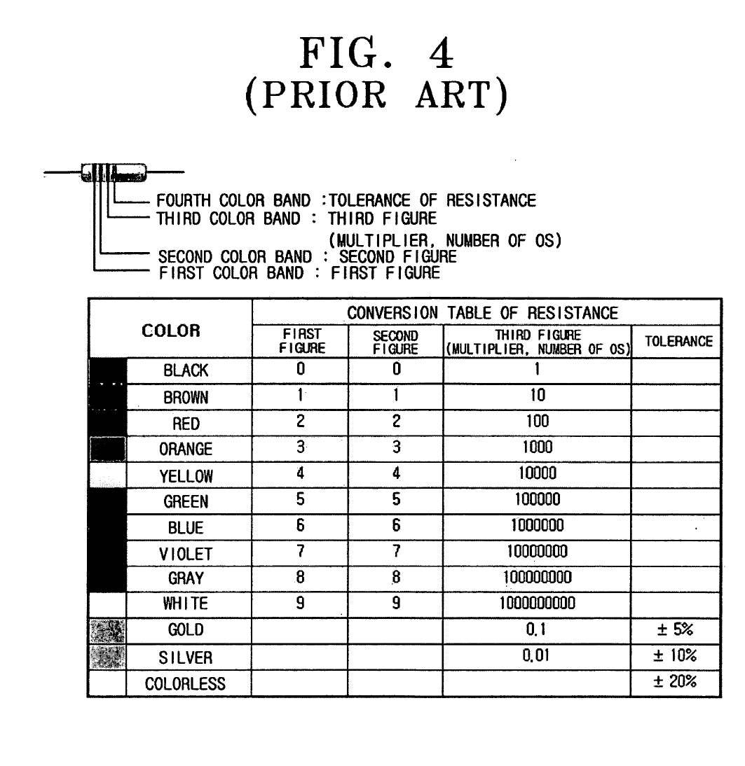

FIG. 4 shows a chart for presenting a method of determining the resistance of a resistor. Referring to FIG. 4, carbon film resistors typically indicate resistance value through bands of colors printed on the body of each resistor. The first two color bands correspond to a numeric value of resistance with the third color band indicating a multiplier. The fourth color band indicates accuracy of the resistance value via percent tolerance. For example, if the color band sequence is brown, black, red and gold, then since brown is the first band and denotes the numeric value of 1, and black is the second band and denotes the numeric value of 0, as can be seen in the resistance conversion table of FIG. 4, the numeric sequence is 1 and 0. The third color band is red, thus the multiplier is 100. The resistance value is obtained by multiplying the first two sequential numbers, which in this example are 1 and 0, by the multiplier, represented by the third band. Therefore, the resistance is 10×100=1000[Ω]=1[kΩ]. Since the fourth band is gold, the tolerance of the resistance 1[kΩ] is approximately 5%. In many circumstances, even though resistors may seem to have the same resistance by virtue of their color coding, actual resistance values range between 950[Ω] and 1050[Ω]. Detection of actual resistance value is required to prove that the resistors have resistances within the 5% tolerance range.

After the detection of resistance values within the tolerance range, the resistance is encoded using an encoding algorithm so that encoded data can be generated (S330). In one exemplary embodiment, the encoding algorithm is the MD5 algorithm. The MD5 standard is defined in Internet Engineering Task Force Request for Comments (IETF RFC) 1321. The encoded data generated in step S330 is stored to the memory chip 20 of the consumable part 100 (S340). The encoded data stored to the memory chip 20 is used to verify genuineness of the consumable part 100.

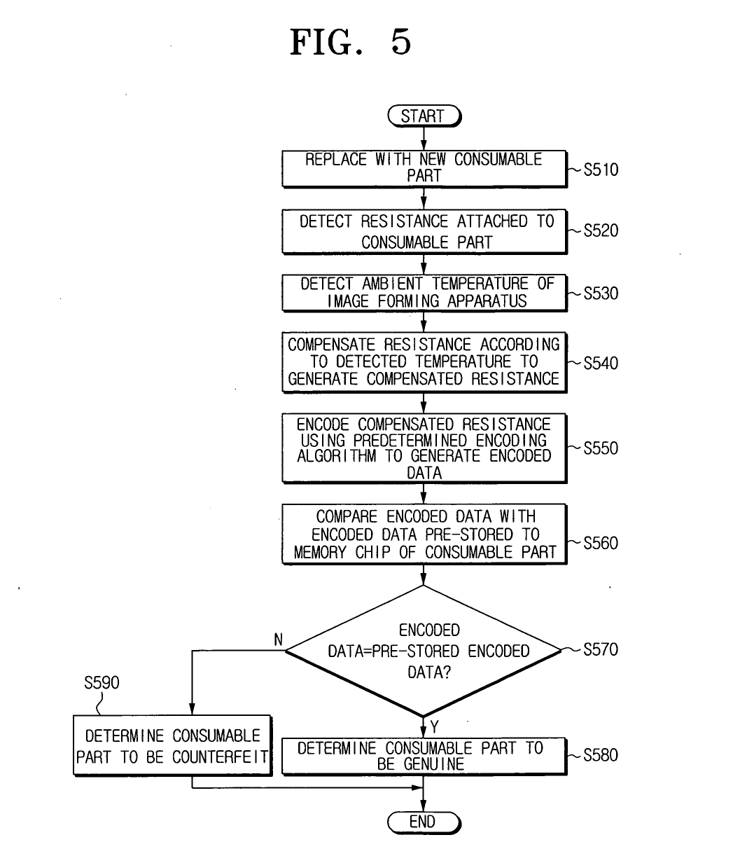

FIG. 5 shows a flowchart of a method for verifying genuineness of a consumable part in an image forming apparatus in accordance with an exemplary embodiment of the present invention. Referring to the flowchart, an old consumable part mounted in the image forming apparatus 200 is replaced with a new consumable part 100 by mounting to the part insertion unit 210 (S510). The ‘consumable part’ 100 refers to a part which needs replacement after being exhausted, such as a belt or a cartridge comprising a drum and toner. After mounting consumable part 100 within image forming apparatus 200, resistance detector 220 in the image forming apparatus 200 detects the resistance of resistor 40 coupled to consumable part 100 (S520). Resistance detector 220 comprises a sensor. In one exemplary embodiment, resistor 40 coupled to consumable part 100 may be a resistor.

Temperature detector 230 detects ambient temperature of the image forming apparatus 200 (S530) and provides the detected temperature value to the resistance compensator 240. Resistance compensator 240 compensates for the detected resistance value supplied from resistance detector 220 according to the temperature detected by temperature detector 230 and accordingly generates a compensated resistance value (S540). Thus, compensation of resistance can allow for variation in resistance according to temperature. The variation of resistance according to temperature can be obtained through a temperature coefficient, which is a parameter of each resistor 40. In one exemplary embodiment, resistor 40 is a carbon resistor with a temperature coefficient of approximately 350 ppm/° C. to −1500 ppm/° C.

For example, when the resistance of a resistor having a temperature coefficient of 300 ppm/° C. at a standard temperature is 1000[Ω], as detected during the manufacture of consumable part 100, if a Celsius temperature scale increases by 10° C. after manufacture, the resistance value increases by 0.3% (=300 ppm/° C.*10° C.). Therefore, the resistance is detected as 1003[Ω] and the increased resistance is 3[Ω]. Resistance compensator 240 compensates the detected resistance by subtracting the increased resistance 3[Ω]. As a result of temperature compensation, resistance value as measured during manufacture can be determined.

The compensated resistance value generated by resistance compensator 240 is supplied to controller 250. Controller 250 encodes the compensated resistance value generated by resistance compensator 240 using an encoding algorithm to generate encoded data (S550). In one exemplary embodiment, the MD5 algorithm is used as the encoding algorithm. The MD5 algorithm generates 128-bit encoded data from the input data. The MD5 standard is defined in IETF RFC 1321. According to the MD5 standard, it is “computationally infeasible” to produce two messages having the same message digest, or to produce any message having a given pre-specified target message digest.

Controller 250 compares the encoded data with data pre-stored in memory chip 20 of consumable part 100, the pre-stored data serving to identify the consumable part (S560). When the encoded data is identical to the pre-stored data in memory chip 20 (S570), the controller determines the mounted consumable part 100 to be genuine (S580).

When the encoded data is different from the pre-stored data (S560), controller 250 determines that consumable part 100 is counterfeit (S590). In this manner, the image forming apparatus 200 is able to identify the genuineness of consumable part 100.

As can be appreciated from the above description, according to various exemplary embodiments of the present invention, the genuineness of consumable part 100, such as a cartridge, can be correctly determined, and use restricted to approved parts. By restricting use to approved consumable parts, product reliability can be improved and damage prevented, thus enhancing the lifespan of image forming apparatus 200.

While the present invention has been particularly shown and described with reference to certain exemplary embodiments thereof, it will be understood by those of ordinary skill in the art that various changes in form and details may be made therein without departing from the spirit and scope of the present invention as defined by the appended claims. For example, certain exemplary embodiments presented the apparatus and method for identifying a consumable part in application to an image forming apparatus. The present invention should not be limited to such an application and may be used in any apparatus wherein the identity of component parts is requested.

What is claimed is:

1. A consumable part, comprising:
a main body having at least one resistor coupled thereto; and
a memory chip for storing encoded data which is generated by applying an encoding algorithm to a detected resistance of the resistor.

2. The consumable part of claim 1, wherein the at least one resistor comprises a resistor in which resistance value varies according to the consumable part.

3. The consumable part of claim 1, wherein resistance value is detected at a predetermined temperature.

4. The consumable part of claim 1, wherein the consumable part refers to a replaceable part consumed during use and comprises one of a cartridge detachably mounted to an image forming apparatus and a belt.

5. The consumable part of claim 1, wherein the predetermined encoding algorithm comprises a Message Digest 5 (MD5) algorithm.

6. The consumable part of claim 1, wherein the encoded data comprises at least 128-bits.

7. The consumable part of claim 1, wherein the resistance value used for encoding falls within a predetermined tolerance range, allowing discrimination between different types of consumable parts.

8. A method for manufacturing a consumable part, the method comprising:
attaching at least one resistor to the consumable part;
generating encoded data by encoding a detected resistance value of the resistor using an encoding algorithm; and
storing the encoded data in a memory chip.

9. The method of claim 8, wherein the at least one resistor comprises a resistor in which resistance value varies according to the consumable part.

10. The method of claim 8, wherein the encoding algorithm comprises an MD5 algorithm embodied in software stored in the memory chip.

11. The method of claim 8, wherein the MD5 algorithm is embodied in software stored in the memory chip.

12. The method of claim 8, wherein the consumable part refers to a replaceable part consumed during use and comprises one of a cartridge detachably mounted to an image forming apparatus and a belt.

13. An image forming apparatus comprising:
a part insertion unit for mounting the consumable part;
a resistance detector for detecting a resistance value of at least one resistor coupled to the consumable part mounted in the part insertion unit; and
a controller for encoding the detected resistance value using an encoding algorithm to generate encoded data, and comparing the generated encoded data with encoded data pre-stored in a memory chip of the consumable part,
wherein the consumable part is determined to be genuine when the generated encoded data is the same as the pre-stored data.

14. The image forming apparatus of claim 13, comprising:
a temperature detector for detecting ambient temperature of the image forming apparatus; and
a resistance compensator for compensating the resistance value detected by the resistance detector based on a difference between the detected temperature and a temperature preset during manufacture of the consumable part and a temperature coefficient,
wherein a compensated resistance value is determined and supplied to the controller prior to encoding.

15. The image forming apparatus of claim 14, wherein the controller is configured to encode the compensated resistance value using an encoding algorithm to generate encoded data, and compare the generated encoded data with encoded data pre-stored in the memory chip of the consumable part,
wherein the consumable part is determined to be genuine when the generated encoded data from the compensated resistance value is the same as the pre-stored data.

16. The image forming apparatus of claim 13, further comprising a storage for storing a software program configured to execute the encoding algorithm.

17. The image forming apparatus of claim 13, wherein the resistance detector comprises a sensor.

18. The image forming apparatus of claim 13, wherein the encoding algorithm comprises an MD5 algorithm.

19. The image forming apparatus of claim 13, wherein the encoded data comprises at least 128-bits.

20. A method for verifying genuineness of a consumable part, the method comprising:
mounting at least one resistor to the consumable part;
detecting resistance of the at least one resistor;
generating encoded data by encoding the resistance value of the at least one resistor using an encoding algorithm; and
comparing the generated encoded data with encoded data pre-stored in a memory chip of the consumable part,
wherein the consumable part is identified as genuine when the generated encoded data is the same as the pre-stored data.

21. The method of claim 20, further comprising the steps of:
detecting ambient temperature of the image forming apparatus; and
generating a compensated resistance value based on a difference between the detected ambient temperature and a temperature preset during the manufacture of the consumable part and a temperature coefficient.

22. The method of claim 21, further comprising:
encoding the compensated resistance value using an encoding algorithm to generate the encoded data; and
comparing the generated encoded data with encoded data pre-stored in the memory chip of the consumable part,
wherein the consumable part is determined to be genuine when the generated encoded data based on the compensated resistance value is the same as the pre-stored data.

23. The method of claim 20, wherein the encoding algorithm comprises an MD5 algorithm.

24. A computer readable medium having stored thereon instructions for verifying genuineness of a consumable part, the computer readable medium comprising:
a first set of instructions for detecting a resistance value of the at least one resistor coupled to the consumable part;
a second set of instructions for generating encoded data by encoding the resistance value of the at least one resistor using an encoding algorithm; and
a third set of instructions for comparing the generated encoded data with encoded data pre-stored in a memory chip of the consumable part,
a fourth set of instructions for verifying the consumable as genuine when the generated encoded data is the same as the pre-stored data.

25. The computer readable medium as claimed in claim 24, further comprising:
a fifth set of instructions for detecting ambient temperature of the image forming apparatus; and
a sixth set of instructions for generating a compensated resistance value based on a difference between the detected ambient temperature and a temperature preset during the manufacture of the consumable part and a temperature coefficient.

26. The computer readable medium as claimed in claim 25, wherein the second set of instructions encodes the compensated resistance value and the fourth set of instructions determine the consumable part to be genuine when the generated encoded data based on the compensated resistance value is the same as the pre-stored data.
